(19) United States
(12) Patent Application Publication
(10) Pub. No.: US 2018/0162175 A1
(43) Pub. Date: Jun. 14, 2018

(54) PNEUMATIC TIRE

(71) Applicant: TOYO TIRE & RUBBER CO., LTD., Itami-shi (JP)

(72) Inventor: Shingo Sano, Itami-shi (JP)

(73) Assignee: TOYO TIRE & RUBBER CO., LTD., Itami-shi (JP)

(21) Appl. No.: 15/804,041

(22) Filed: Nov. 6, 2017

(30) Foreign Application Priority Data
Dec. 8, 2016 (JP) 2016-238749

(51) Int. Cl. B60C 11/13; B60C 11/03

(52) U.S. Cl. CPC B60C 11/1307; B60C 11/0302

(57) ABSTRACT

To provide a pneumatic tire including on a tread surface thereof; a center main groove extending in a tire circumferential direction; a shoulder main groove extending in the tire circumferential direction at a position away from the center main groove in a tire width direction; and a plurality of inclined grooves formed at predetermined intervals in the tire circumferential direction, wherein each inclined groove includes a first inclined portion extending from the center main groove toward the shoulder main groove while increasing a width thereof, the first inclined portion extending at a first angle α with respect to the tire circumferential direction, and a second inclined portion continuously formed with the first inclined portion, the second inclined portion extending at a second angle smaller than the first angle.

### CROSS-REFERENCE TO RELATED APPLICATIONS

This application claims priority of Japanese Patent Application No.: 2016-238749 filed on Dec. 8, 2016, the content of which is incorporated herein by reference.

### BACKGROUND OF THE INVENTION

### Technical Field

The present invention relates to a pneumatic tire.

### Related Art

JP-A-2007-112218 discloses a pneumatic tire where inclined grooves are formed on a tread surface. In this pneumatic tire, an inclined wall portion which forms the inclined groove is inclined with respect to a surface of a land portion at an acute angle.

### SUMMARY

However, in the above-mentioned tire configuration, although effective drainage of water from a tread surface (wet performance), resistance against non-uniform wear of blocks and straight traveling performance of the tire have been taken into consideration, these properties are still insufficient or less than optimal.

Accordingly, it is an object of the present invention to provide a pneumatic tire which can exhibit excellent performances in all of wet property, uneven wear resistance and straight traveling performance of the tire.

To overcome the above-mentioned drawbacks, according to a first aspect of the present invention, there is provided a pneumatic tire which includes, on a tread surface thereof;

a center main groove extending in a tire circumferential direction;

a shoulder main groove extending in the tire circumferential direction at a position away from the center main groove in a tire width direction; and

a plurality of inclined grooves formed at predetermined intervals in the tire circumferential direction, wherein each inclined groove includes a first inclined portion extending from the center main groove toward the shoulder main groove while increasing a width thereof, the first inclined portion extending at a first angle with respect to the tire circumferential direction, and a second inclined portion continuously formed with the first inclined portion, the second inclined portion extending at a second angle smaller than the first angle with respect to the tire circumferential direction.

With such a configuration, water which flows through the center main groove is mainly directly discharged in the tire circumferential direction and part of water is discharged in the width direction through the inclined grooves. Further, in the inclined groove, the first inclined portion and the second inclined portion are made different from each other in an inclination angle and hence, a width of a formed land portion can be ensured whereby rigidity of the tire can be made uniform in the tire circumferential direction thus increasing uneven wear resistance and straight traveling performance.

It is preferable that the inclined groove has an inclined surface gradually projecting toward the inside as the inclined groove extends toward a groove bottom.

With such a configuration, rigidity of a land portion which is formed by the inclined grooves can be increased and hence, balance in rigidity can be acquired between the land portion and other portions whereby uneven wear is unlikely to occur.

It is preferable that a plurality of shoulder blocks are formed in the tire circumferential direction by a plurality of shoulder lateral grooves extending from the shoulder main groove toward the outside in the tire width direction, and

the shoulder block has an inclined surface whose width and depth are decreased from a step-in side toward a kick-out side in a corner portion where the shoulder main groove and the shoulder lateral groove intersect with each other.

With such a configuration, even when the corner portion of the shoulder block is disposed on the step-in side, rigidity of the corner portion can be increased. Accordingly, balance in rigidity can be maintained between the shoulder blocks disposed adjacently to each other whereby uneven wear is unlikely to occur.

It is preferable that a plurality of shoulder blocks are formed in the tire circumferential direction by a plurality of shoulder lateral grooves extending from the shoulder main groove toward the outside in the tire width direction, and

the shoulder block has, in a corner portion where the shoulder main groove and the shoulder lateral groove intersect with each other, an inclined surface extending toward the shoulder main groove side and an inclined surface extending toward the shoulder lateral groove side.

With such a configuration, even when a corner portion of the shoulder block extends toward a center side and an extending portion forms a step-in side, balance in rigidity can be acquired by increasing rigidity of the corner portion whereby uneven wear is unlikely to occur.

It is preferable that the pneumatic tire has a pair of the center main grooves formed with a predetermined distance therebetween in the tire width direction, and an auxiliary groove formed in a center rib which is formed between the center main grooves, the auxiliary groove positioned on an extension of the first inclined portion.

With such a configuration, water which flows into the auxiliary groove forms a flow heading toward the first inclined portion and hence, draining performance from the center main groove to the inclined groove can be enhanced.

It is preferable that a plurality of mediate blocks are formed between the center main groove and the shoulder main groove in the tire circumferential direction by the inclined grooves,

the shoulder main groove extends in a zigzag shape in the tire circumferential direction, the shoulder main groove having an inwardly inclined portion which gradually approaches the center main groove toward a tire rotating direction and an outwardly inclined portion which gradually moves away from the center main groove toward the tire rotating direction, and

a mediate auxiliary groove extending toward the inside in the tire width direction from a merging point of the inwardly inclined portion and the outwardly inclined portion of the shoulder main groove be formed in the mediate block.

According to the present invention, draining performance can be enhanced by forming the inclined groove. Further, by making the first inclined portion and the second inclined portion which form the inclined groove different from each other in an inclination angle and hence, a width of the formed land portion can be made uniform. Accordingly, rigidity of the land portion can be made uniform in the tire circumferential direction and hence, uneven wear resistance and straight traveling performance can be enhanced.

### BRIEF DESCRIPTION OF THE DRAWINGS

The foregoing and the other features of the present invention will become apparent from the following description and drawings of an illustrative embodiment of the invention in which:

FIG. 1 is a partially developed view of a tread surface of a pneumatic tire according to this embodiment; and

FIG. 2 is a partially enlarged perspective view of a mediate block shown in FIG. 1 and an area around the mediate block.

### DETAILED DESCRIPTION OF EMBODIMENT

Hereinafter, an embodiment according to the present invention is described with reference to attached drawings. The description made hereinafter essentially shows just one example, and does not intend to limit the present invention, products to which the present invention is applied, or its applications. Further, drawings are schematically shown and hence, ratios of respective sizes and the like may differ from actual ratios of sizes and the like.

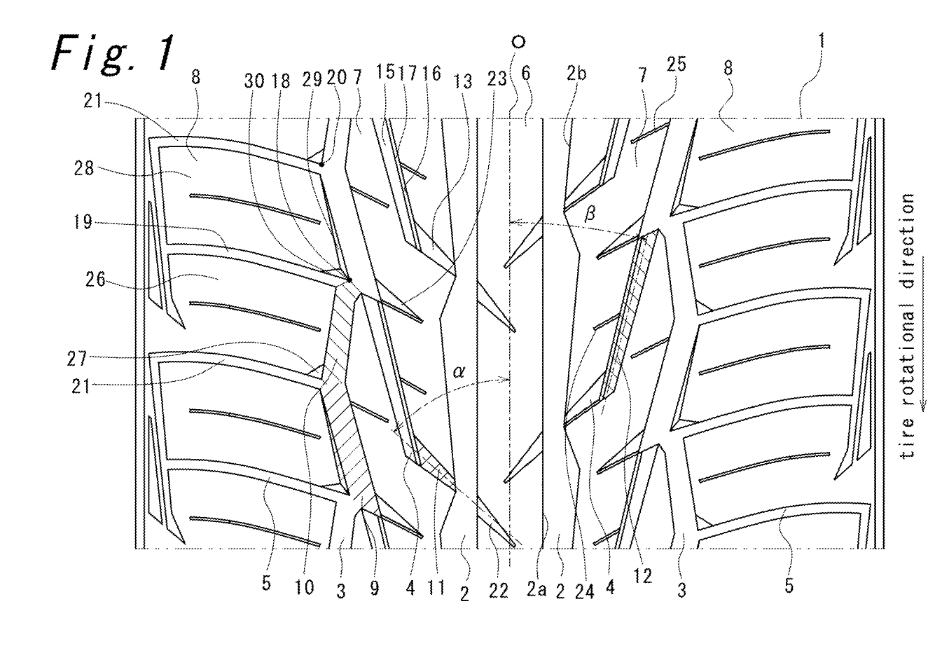

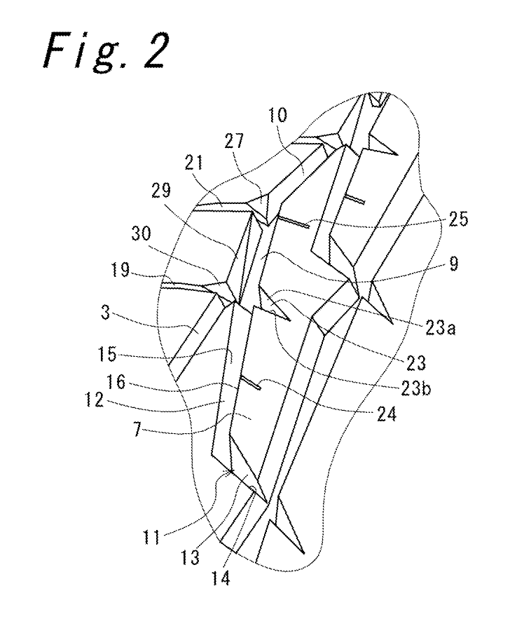

FIG. 1 is a partially developed view of a tread surface 1 of a pneumatic tire according to this embodiment and FIG. 2 is a partially enlarged perspective view of the tread surface 1 of the pneumatic tire. On the tread surface 1, land portions, that is, a center rib 6, mediate blocks 7, and shoulder blocks 8 are formed by center main grooves 2, shoulder main grooves 3, inclined grooves 4 and shoulder lateral grooves 5. In FIG. 1, a vertical direction agrees with a tire circumferential direction, and a lateral direction agrees with a tire width direction.

The center main grooves 2 are formed with a predetermined distance therebetween on both sides of a center line O extending in a tire circumferential direction on the tread portion. The center rib 6 is formed by inner side surfaces 2a of the center main grooves 2. The inner side surfaces 2a of the center main groove 2 extend linearly in the tire circumferential direction.

An outer side surface 2b of the center main groove 2 moves gradually away from the inner side surface of the center main groove 2 from a proximate position where a distance between the outer side surface 2b and the inner side surface becomes minimum toward a direction opposite to a tire rotating direction, approaches the inner side surface again from a remote position where the outer side surface 2b moves most away from the inner side surface, and reaches the next proximate position. That is, the center main groove 2 is formed by repeating a mode or a pattern where a width of the center main groove 2 is gradually increased from a narrow width portion and is decreased to the narrow width portion again in a direction opposite to the tire rotating direction, that is, in a water drainage direction when the pneumatic tire travels on a wet road surface.

The shoulder main grooves 3 extend in a zigzag shape in the tire circumferential direction. That is, the shoulder main groove 3 is constituted of inwardly inclined portions 9 each of which gradually approaches the center main groove 2 in the tire rotating direction, and outwardly inclined portions 10 each of which gradually moves away from the center main groove 2 in the tire rotating direction. The inwardly inclined portion 9 is positioned on an extension of a second inclined portion 12 of the inclined groove 4 described later.

The inclined groove 4 is formed of a first inclined portion 11 and a second inclined portion 12 which is continuously formed with the first inclined portion 11.

The first inclined portion 11 extends gradually outward in a tire width direction from the center main groove 2 toward the tire reverse rotational direction. A center line of the first inclined portion 11 is inclined at a first angle α with respect to the tire circumferential direction. In this embodiment, although the first angle α is set to approximately 50°, it is sufficient that the first angle α be set to a value which falls within a range of from 45° to 55°. The first inclined portion 11 is formed such that an opening width of the first inclined portion 11 on the tread surface 1 is gradually increased as the first inclined portion 11 moves away from the center main groove 2. The first inclined portion 11 has a triangular shape in cross section, and is formed of a first inclined surface 13 and a first vertical surface 14. On a bottom surface portion of the first inclined portion 11 where the first inclined surface 13 and the first vertical surface 14 intersect with each other, a sipe (not shown in the drawing) is formed so that a depth of the first inclined portion 11 is further increased. The first inclined surface 13 is formed such that an inclination angle between the first inclined surface 13 and the vertical direction of the tread surface 1 is gradually decreased as the first inclined surface 13 is disposed away from the center main groove 2.

The second inclined portion 12 extends gradually outward in the tire width direction from a terminal end of the first inclined portion 11 toward the tire reverse rotational direction, and a center line of the second inclined portion 12 is inclined at a second angle β with respect to the tire circumferential direction. The second angle β is set to a small value compared to the first angle α. In this embodiment, although the second angle β is set to approximately 15°, it is sufficient that the second angle β be set to a value which falls within a range of from 10° to 20°. The second inclined portion 12 is formed such that an opening width of the second inclined portion 12 on the tread surface 1 is gradually increased as the second inclined portion 12 moves away from the first inclined portion 11. The second inclined portion 12 has a trapezoidal shape in cross section, and is defined by a second inclined surface 15, a second vertical surface 16, and a bottom surface 17. On a portion where the second inclined surface 15 and the second vertical surface 16 intersect with each other, a sipe (not shown in the drawing) deeper than the bottom surface 17 is formed. An inclination angle of the second inclined surface 15 is gradually decreased as the second inclined surface 15 is disposed away from the first inclined portion 11. A terminal position of the second inclined portion 12 forms an end portion of the inwardly inclined portion 9 of the shoulder main groove 3 so that water which flows through the second inclined portion 12 can be made to smoothly flow toward the inwardly inclined portion 9.

The shoulder lateral groove 5 is formed of: a first shoulder lateral groove 19 which extends in an arcuate shape in a tire width direction from an inner merging point 18 where the inwardly inclined portion 9 and the outwardly inclined portion 10 of the shoulder main groove 3 are merged with each other; and a second shoulder lateral groove 21 which extends in an arcuate shape in the tire width direction from an outer merging point 20.

A plurality of center auxiliary grooves 22 which respectively extend inward from both side edges of the center rib 6 are formed on the center rib 6. Each center auxiliary groove 22 is positioned on the center line of the first inclined portion 11. Each center auxiliary groove 22 extends obliquely in the tire rotating direction toward the inside of the center rib 6 from the side edge of the center rib 6. Further, each center auxiliary groove 22 is terminated at a position slightly beyond the center line O. The respective center auxiliary grooves 22 are formed at fixed intervals in the tire circumferential direction. On both side portions of the center rib 6, the center auxiliary grooves 22 are formed in a positionally displaced manner in the tire circumferential direction.

The Mediate block 7 is surrounded by the center main groove 2, the shoulder main groove 3 and the inclined grooves 4. The mediate block 7 has a longitudinally-elongated shape extending in the tire circumferential direction.

One end portion of the mediate block 7 formed by the inclined groove 4 and the center main groove 2 ensures a sufficient width by making the first inclined portion 11 and the second inclined portion 12 which form the inclined groove 4 different from each other in an inclination angle. Further, a side surface of one end portion of the mediate block 7 is formed of the first inclined surface 13 of the first inclined portion 11. With such a configuration, rigidity of one end portion of the mediate block 7 is enhanced.

A mediate auxiliary groove 23 is formed on the mediate block 7, and the mediate auxiliary groove 23 extends obliquely inward from the inner merging point 18 of the shoulder main groove 3. The mediate auxiliary groove 23 is defined by an inclined surface 23a and a vertical surface 23b. On a portion where the inclined surface 23a and the vertical surface 23b intersect with each other, a sipe (not shown in the drawing) deeper than the mediate auxiliary groove 23 is formed. The mediate auxiliary groove 23 is formed such that a center line of the mediate auxiliary groove 23 is disposed approximately parallel to the center line of the first inclined portion 11.

A first slit 24 is formed between the first inclined portion 11 and the mediate auxiliary groove 23 The first slit 24 is disposed approximately parallel to the center lines of the first inclined portion 11 and the mediate auxiliary groove 23. A second slit 25 extends obliquely inward from a portion of the shoulder main groove 3 in the vicinity of the outer merging point 20. Although the second slit 25 is disposed approximately parallel to the first slit 24, the second slit 25 is longer than the first slit 24 and extends to an area in the vicinity of the second inclined portion 12.

On the other end portion of the mediate block 7 which is defined by the inclined groove 4 and the shoulder main groove 3, the second inclined portion 12 and the inwardly inclined portion 9 are formed approximately parallel to each other and hence, the other end portion can ensure a sufficient width. Further, a side surface of the other end portion of the mediate block 7 is formed of the second inclined surface 15 of the second inclined portion 12. With such a configuration, rigidity of the mediate block 7 at the other end portion is enhanced.

The shoulder block 8 is surrounded by the shoulder main groove 3 and the shoulder lateral groove 5.

A portion which is surrounded by the outwardly inclined portion 10, the first shoulder lateral groove 19, and the second shoulder lateral groove 21 forms a first shoulder portion 26. In the first shoulder portion 26, a third inclined surface 27 is formed on a corner portion which is defined by the outwardly inclined portion 10 and the second shoulder lateral groove 21.

A portion which is surrounded by the inwardly inclined portion 9, the first shoulder lateral groove 19 and the second shoulder lateral groove 21 forms a second shoulder portion 28. In the second shoulder portion 28, a fourth inclined surface 29 and a fifth inclined surface 30 extend from a corner portion which is defined by the inwardly inclined portion 9 and the first shoulder lateral groove 19. The fourth inclined surface 29 is formed on an inwardly inclined portion 9 side of the second shoulder portion 28, and the fourth inclined surface 29 is formed such that an inclination angle with respect to the vertical direction of the tread surface 1 is gradually decreased toward the outer merging point 20 from the inner merging point 18. The fifth inclined surface 30 is formed on a first shoulder lateral groove 19 side of the second shoulder portion 28, and the fifth inclined surface 30 is formed such that an inclination angle with respect to the vertical direction of the tread surface 1 is gradually decreased toward the outside in the tire width direction from the inner merging point 18.

When the pneumatic tire which includes the tread surface 1 having the above-mentioned configuration travels on a wet road surface, the respective grooves function as follows.

In the center main groove 2, water flows straightly due to the rotation of the tire. In this embodiment, the width of the center main groove 2 is alternately increased and decreased in the tire circumferential direction. Further, at the portion of the center main groove 2 where the width of the center main groove 2 becomes narrowest, the center auxiliary groove 22 is merged to the center main groove 2 from the center side of the center rib 6, and the first inclined portion 11 of the inclined groove 4 extends sideward on an extension of the center auxiliary groove 22. With such a configuration, water which flows through the center main groove 2 is temporarily brought into a compressed state and is influenced by the flow from the center auxiliary groove 22 so that not only water is made to flow straightly in the tire circumferential direction but also water is made to easily flow toward the inclined groove 4 side.

Water which flows through the inclined groove 4 merges with water which flows through the shoulder main groove 3 formed into a zigzag shape. In the shoulder main groove 3, although water is substantially made to flow in the tire circumferential direction, due to water which flows into the shoulder main groove 3 from the second inclined portion 12 of the inclined groove 4, the flow of water toward the inwardly inclined portion 9 is formed. The merging portion is also the merging point between the inwardly inclined portion 9 and the outwardly inclined portion 10, and a stepped portion is formed on the merging portion. Due to such a configuration, water which flows through the outwardly inclined portion 10 is divided in two thus forming the flow of water which flows into the inwardly inclined portion 9 and the flow of water which flows into the first shoulder lateral groove 19. The flow of water toward the inwardly inclined portion 9 is the flow which follows the flow of water from the second inclined portion 12 and hence, water smoothly flows toward the inwardly inclined portion 9. Further, the flow of water in the inwardly inclined portion 9 is divided in two thus forming the flow of water which flows into the outwardly inclined portion 10 and the flow of water which flows into the second shoulder lateral groove 21. The flow of water in the inwardly inclined portion 9 forms the flow toward the outside in the tire width direction. Although the inwardly inclined portion 9 has a smaller flow-passage cross-sectional area than the outwardly inclined portion 10, the flow of water toward the second shoulder lateral groove 21 becomes smooth. While the direction of the flow of water toward the first shoulder lateral groove 19 side is changed by the stepped portion which extends to the inwardly inclined portion 9 from the outwardly inclined portion 10, the flow of water toward the first shoulder lateral groove 19 side is facilitated by the flow of water toward the tire width direction generated by the mediate auxiliary groove 23.

As described above, when the pneumatic tire travels on a wet road surface, on the tread surface 1, the flow of water at the center main groove 2, the flow of water from the center main groove 2 to the shoulder main groove 3 through the inclined groove 4, and the flow of water from the shoulder main groove 3 to the shoulder lateral groove 5 can be smoothly formed. Accordingly, the tire including the tread surface 1 having the above-mentioned configuration can exhibit excellent draining performance.

Further, the pneumatic tire which includes the tread surface 1 having the above-mentioned configuration performs the following functions at the time of traveling on a road surface.

That is, in the mediate block 7, the first inclined surface 13 and the second inclined surface 15 are formed thus increasing rigidity of the mediate block 7. Particularly, the first inclined portion 11 reinforces a step-in side of the mediate block 7, and the second inclined portion 12 reinforces a kick-out side of the mediate block 7. in the shoulder block 8, the third inclined surface 27, the fourth inclined surface 29, and the fifth inclined surface 30 are formed. All of these third to fifth inclined surfaces 27, 29, 30 reinforce a step-in side of the shoulder block 8. Accordingly, by maintaining balance in rigidity at the time of traveling, uneven wear is unlikely to occur as a whole. Particularly, between the first shoulder portion 26 and the second shoulder portion 28 disposed adjacently to each other with the first shoulder lateral groove 19 sandwiched therebetween, the difference in wear amount is unlikely to be generated due to the formation of the fourth inclined surface 29 and the fifth inclined surface 30 on the second shoulder portion 28. With such a configuration, the mediate block 7 and the shoulder block 8 respectively having inclined surfaces exhibit excellent uneven wear resistance.

In the mediate block 7, a predetermined width can be ensured on a tire step-in side by the inclined groove 4 which is formed of the first inclined portion 11 and the second inclined portion 12 differing from each other in an inclination angle. With such a configuration, the mediate block 7 has substantially the fixed width in the tire circumferential direction as a whole and hence, rigidity of the mediate block 7 in the tire circumferential direction can be made substantially uniform. That is, the tire including the mediate block 7 having the above-mentioned configuration can exhibit excellent straight traveling performance at the time of traveling.

What is claimed is:

1. A pneumatic tire comprising on a tread surface thereof:
a center main groove extending in a tire circumferential direction;
a shoulder main groove extending in the tire circumferential direction at a position away from the center main groove in a tire width direction; and
a plurality of inclined grooves formed at predetermined intervals in the tire circumferential direction, wherein each inclined groove includes a first inclined portion extending from the center main groove toward the shoulder main groove while increasing a width thereof, the first inclined portion extending at a first angle with respect to the tire circumferential direction, and a second inclined portion continuously formed with the first inclined portion, the second inclined portion extending at a second angle smaller than the first angle with respect to the tire circumferential direction.

2. The pneumatic tire according to claim 1, wherein the inclined groove has an inclined surface gradually projecting toward the inside as the inclined groove extends toward a groove bottom.

3. The pneumatic tire according to claim 1, wherein a plurality of shoulder blocks are formed in the tire circumferential direction by a plurality of shoulder lateral grooves extending from the shoulder main groove toward the outside in the tire width direction, and
the shoulder block has an inclined surface whose width and depth are decreased from a step-in side toward a kick-out side in a corner portion where the shoulder main groove and the shoulder lateral groove intersect with each other.

4. The pneumatic tire according to claim 1, wherein a plurality of shoulder blocks are formed in the tire circumferential direction by a plurality of shoulder lateral grooves extending from the shoulder main groove toward the outside in the tire width direction, and
the shoulder block has, in a corner portion where the shoulder main groove and the shoulder lateral groove intersect with each other, an inclined surface extending toward the shoulder main groove side and an inclined surface extending toward the shoulder lateral groove side.

5. The pneumatic tire according to claim 1, including
a pair of the center main grooves formed with a predetermined distance therebetween in the tire width direction, and
an auxiliary groove formed in a center rib which is formed between the center main grooves, the auxiliary groove positioned on an extension of the first inclined portion.

6. The pneumatic tire according to claim 1, wherein a plurality of mediate blocks are formed between the center main groove and the shoulder main groove in the tire circumferential direction by the inclined grooves,
the shoulder main groove extends in a zigzag shape in the tire circumferential direction, the shoulder main groove having an inwardly inclined portion which gradually approaches the center main groove toward a tire rotating direction and an outwardly inclined portion which gradually moves away from the center main groove toward the tire rotating direction, and
a mediate auxiliary groove extending toward the inside in the tire width direction from a merging point of the inwardly inclined portion and the outwardly inclined portion of the shoulder main groove is formed in the mediate block.
